(19) United States
(12) Patent Application Publication
(10) Pub. No.: US 2009/0173509 A1
(43) Pub. Date: Jul. 9, 2009

(54) Sand plow

(75) Inventor: Philip J. Bahler, Tolland, CT (US)

Correspondence Address: IRA S. DORMAN, 330 ROBERTS STREET, SUITE 200, EAST HARTFORD, CT, 06108, US

(73) Assignee: Toolbros Innovators LLC

(21) Appl. No.: 12/313,520

(22) Filed: Nov. 21, 2008

Related U.S. Application Data
(60) Provisional application No. 61/004,338, filed on Nov. 27, 2007.

(51) Int. Cl. A01B 1/06

(52) U.S. Cl. 172/372

(57) ABSTRACT

A manual plow tool, effective in both forward and backward directions, has a head of generally triangular cross section comprised of two working plates, each having a bottom blade edge. Surfaces on a mounting plate and on a perpendicular guide panel facilitate guided movement along an outer course of pavers adjacent to which the surface of a coarse foundation layer is to be substantially uncovered.

### CROSS REFERENCE TO RELATED APPLICATION

The application claims the benefit of U.S. Provisional patent Application No. 61/004,338, filed Nov. 27, 2007, the entire specification of which is incorporated hereinto by reference thereto.

### BACKGROUND OF THE INVENTION

Edge-restraint systems are usually used in building patios, driveways, walkways and the like to maintain the pavers (e.g., bricks and blocks) against lateral displacement. Such systems generally comprise elongate components having a flat base wall and an upstanding restraining wall. It is most important that, upon installation, the base wall of the edge-restraint components rest upon a stable surface.

Paver beds normally consist of a compacted, coarse particulate bottom layer of gravel, crushed stone, aggregate, or the like, covered by a layer of sand in which the pavers are set. To provide the necessary stable support for the edge-restraint components, it is necessary that a swath of the sand bed adjacent the paver edge be displaced to uncover (or at least substantially uncover) the surface of the coarse particulate base; of course, the depths of sand layers, and the heights of pavers, vary considerably.

### SUMMARY OF THE INVENTION

Accordingly, it is a broad object of the present invention to provide a hand tool that is effective for displacing material, such as sand, constituting an upper layer of a setting bed for pavers and the like.

A more specific object of the invention is to provide such a tool which can be used effectively, by movement in either a forward or a backward direction, and which can readily and accurately be adjusted to accommodate various layer depths and paver dimensions.

Additional objects of the invention are to provide a tool, having the foregoing features and advantages, which is convenient and facile to use and which is of incomplex construction and economical manufacture.

It has now been found that the foregoing and related objects are attained by the provision of a manual tool that includes a plow head of generally triangular cross section; a guide piece having an underlying guide surface, adjustably attached to the plow head and comprising an element extending rearwardly therefrom (in the orientation of normal use); means for attaching a mounting portion of the plow head to the guide piece, for relative movement and for selectively affixing the plow head at a desired level; and means for attaching a handle to the tool. The plow head of the tool is comprised of a mounting plate and first and second working plates. A lateral edge of each working plate is joined to one of the opposite lateral edges of the mounting plate, and the other lateral edges of the working plates are joined to one another to form a frontally disposed, generally apical portion on the head. Each working plate has a blade edge that extends transversely between its opposite lateral edges, which blade edges lie substantially on a common plane. The guide piece is attached to the plow head for movement in a direction generally perpendicular to the common plane on which the bottom blade edges lie, and it can be affixed, by the means for attaching, in selected positions in which an underlying surface of the rearwardly extending element of the guide piece is generally parallel to, and spaced above (in the orientation of normal use), the common plane.

The plates of which the plow head is comprised will normally be substantially planar and with flat exterior surfaces, and the underlying guide surface of the guide piece will normally be disposed substantially perpendicular to the exterior surface of the mounting plate. Preferably, the plates of the plow head will form an isosceles right triangle, and the bottom blade edges on the working plates will be rectilinear.

The mounting plate will advantageously be of one-piece construction, to integrally provide the mounting portion thereon, which portion will most desirably have a scale with indicia that indicate the distance between the underlying guide surface on the guide piece and the common plane on which the blade edges lie. Typically, the mounting plate will be formed with a pair of parallel slots, extending in the direction of relative movement of the plow head and the guide piece (generally, perpendicular to the reference plane), and the means for attaching the plow head and the guide piece will typically comprise a pair of elongate fasteners, extending from a panel of the guide piece and slidably received in the parallel slots. The guide piece will advantageously take the form of a bracket comprised of first and second panels disposed perpendicular to one another, one of the panels having the underlying guide surface thereon and the other serving to engage the means for attaching the guide piece to the plow head. An end portion of the handle employed, and the second panel of the guide piece, will have cooperating engaging structures thereon; disengageable fastener means will desirably join the engaging structures to one another in such a way as to enable pivotal movement of the handle relative to the plow head.

### BRIEF DESCRIPTION OF THE DRAWINGS

FIG. 1 is a perspective view of a manual plow tool embodying the present invention, viewed from the front and including an adjustable-length handle;

FIG. 2 is a perspective view of the plow tool, viewed from the rear;

FIGS. 3, 4, and 5 are, respectively, top plan, front, and end elevational views of the tool of the foregoing figures;

FIG. 6 is a perspective view of the plow head employed in the tool illustrated;

FIG. 7 is an elevational view showing the mounting plate of the plow head, drawn to a somewhat enlarged scale; and

FIG. 8 is a perspective view of the mounting bracket component of the tool.

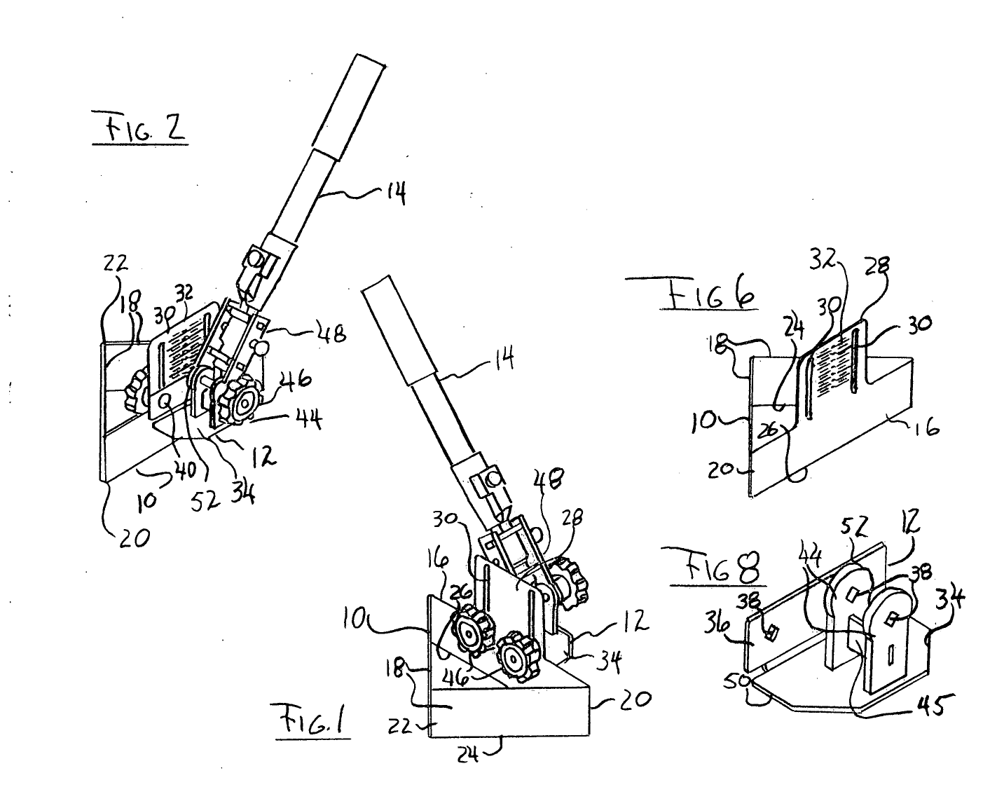

### DETAILED DESCRIPTION OF THE PREFERRED AND ILLUSTRATED EMBODIMENT

Turning now in detail to the appended drawings, therein illustrated is a manual plow tool embodying the present invention and consisting of a plow head, a mounting bracket (or guide piece), and a handle, generally designated respectively by the numerals 10, 12, and 14. The plow head 10 consists of a mounting plate 16 and two working plates 18, which are joined to one another to form an isosceles right triangle (i.e., having 45° corners 20 and a 90° apex 22 at the front). The three plates 16, 18 are all of planar form, with flat exterior surfaces, and will typically be made of steel.

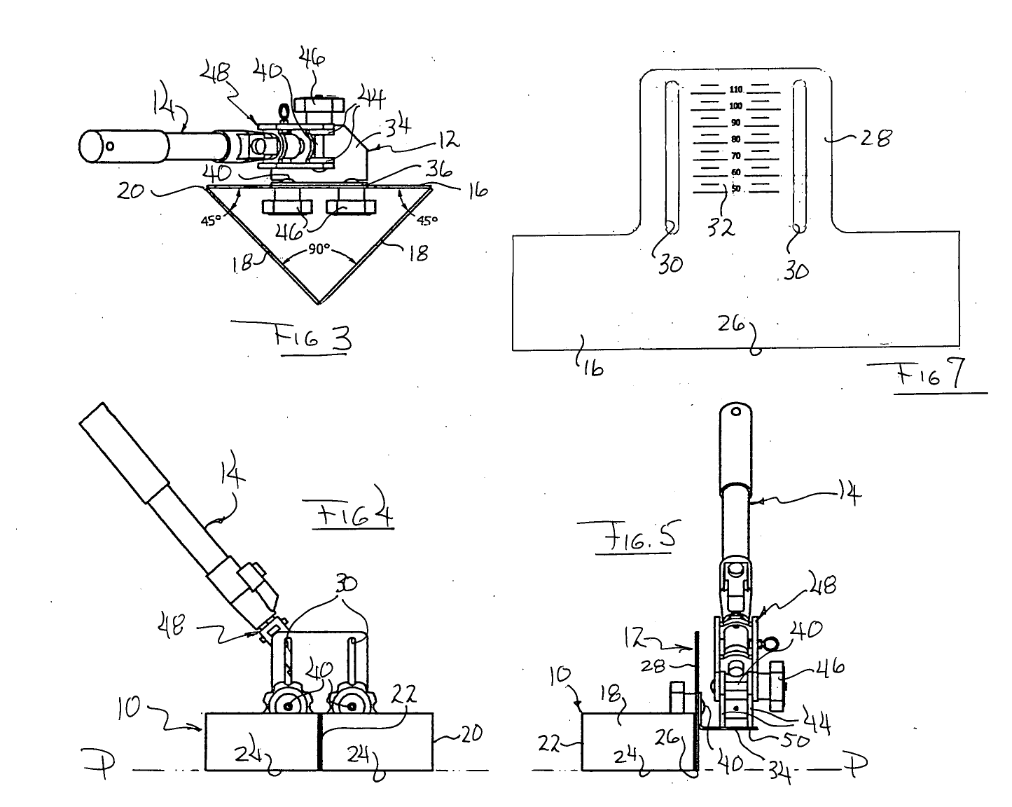

The bottom blade edges 24 on the working plates 18 are rectilinear and, as is best seen in FIGS. 4 and 5, they lie on a common plane P. The bottom edge 26 of the mounting plate 16 also lies on the common plane P, but that is not necessary for the tool to function effectively.

The mounting plate 16 includes an integral, upstanding mounting portion 28, in which is formed a pair of parallel slots 30; the slots 30 extend on axes that are perpendicular to the common plane P (but again, that is not essential). A distance scale 32, including (as is best seen in FIG. 6) numerical indicia, is provided between the slots 30.

As is best seen in FIGS. 2, 3, 5 and 8, the mounting bracket 12 consists of a support panel 34, and a lateral panel 36, which is integral therewith and disposed in a right-angular relationship thereto. A pair of square apertures 38 (only one of which is seen in FIG. 8) extend through the panel 36 and are adapted to receive the square lug portion formed under the head of a common carriage bolt 40. Two such carriage bolts 40 extend from the lateral panel 36 and through the parallel slots 30 in the mounting portion 28 of the mounting plate 16, for the receipt of hand knobs 46 on their free outer ends; the hand knobs of course have threaded passages for engaging the end portions of the carriage bolts 40 and to permit the panel 36 to be secured against the mounting plate 16 by tightening the knobs 46.

A pair of mounting legs 44 extend upwardly from the support panel 34 of the mounting bracket 12 (being affixed thereto by means such as swaging of elements received in holes of the panel, not shown). The legs are joined to one another by a short tie-bar 45, to provide added strength, and they have square apertures 38 in their free upper end portions.

The legs 44 receive a bifurcated mounting fixture, generally designated by the numeral 48, provided on the end of the handle 14, and are embraced thereby. A carriage bolt 40 extends through the apertures 38 in the mounting legs 44 and through aligned apertures (not visible) in the elements of the bifurcated end fixture 48; it also threadably engages a hand knob 46 on its free outer end. As will be appreciated, this arrangement pivotably attaches the handle 14 to the mounting bracket 12, thereby enabling facile adjustment (in a vertical plane, in the orientation of normal use of the tool) for most convenient and effective use; the knob 46 may be tightened to secure the handle at a desired attitude.

As can be seen in FIG. 2, the upper edge 52 on the lateral panel 36 of the mounting bracket 12 registers with the lines of the scale 32 provided on the mounting portion 28 of the plate 16. The numbers on the scale 32 represent the distance between the common plane P and the underlying guide surface 50 provided by the support panel 34; they thus enable ready determination of the spacing of the plow head 10 below the support panel 34 and, in turn, ready control of the depth of sand displacement that will be effected by the bottom blade edges 24.

As will be appreciated, the tool of the invention is normally used by running it along an outer course of pavers, with the guide surface 50 of the support panel 34 and the exterior surface of the mounting plate 16 bearing against the top and side surfaces of the pavers, respectively. Because of the unique triangular shape of the plow head 10, sand displacement can be effected by movement of the tool in either or both directions (i.e., reciprocally).

It will be appreciated that many variations can be made in the tool depicted and described without departing from the concepts and definition of the invention. For example, although the working plates of the plow head are described as being of flat, planar construction, curved plates, or indeed multiple plates capable of producing equivalent plowing actions, can be substituted. Similarly, although the mounting portion of the head is described as being an integral element of the mounting plate, separate elements, joined together, can be used as well. Finally, it will be appreciated that the means for joining the plow head and/or handle to the guide piece may take a variety of different forms and, while metal construction has been mentioned above, the parts of the tool may be fabricated from suitable plastics, and the like, if preferred.

Thus, it can be seen that the present invention provides a hand tool that is effective for displacing material, such as sand, constituting an upper layer of a setting bed for pavers and the like. The tool is convenient and facile to use, by movement in either a forward direction or a backward direction; it can readily and accurately be adjusted to accommodate various layer depths and paver dimensions, and it is of incomplex construction and economical manufacture.

1. A manual plow tool for displacing a material, constituting an upper layer of a setting bed for pavers and the like, away from edge-defining structure, comprising:
a plow head of generally triangular cross section and comprised of a mounting plate and first and second working plates, said mounting plate having opposite lateral edges, a bottom portion extending transversely therebetween, and a mounting portion thereon, and each of said working plates having opposite lateral edges and a bottom blade edge extending transversely therebetween, one of said opposite lateral edges of each of said working plates being joined, respectively, to one or the other of said opposite lateral edges of said mounting plate, and the other of said opposite lateral edges of said working plates being join to one another and forming a frontally disposed, generally apical portion on said head, said bottom blade edges of said working plates lying substantially on a common plane;
a guide piece adjustably attached to said plow head and comprising an element, extending rearwardly therefrom, having an underlying guide surface thereon;
means for attaching said mounting portion of said plow head to said guide piece for relative movement, in a direction generally perpendicular to said common plane, and for affixing said plow head in selected positions with said guide surface of said guide piece element generally parallel to, and spaced above, said common plane; and
means on said tool for attaching a handle.

2. The tool of claim 1 wherein each of said plates comprising said plow head is substantially planar and has a flat exterior surface, and wherein said exterior surface of said mounting plate is disposed substantially perpendicular to said underlying guide surface of said guide piece.

3. The tool of claim 1 wherein said working plates are joined to one another at an angle of substantially 90° and to said mounting plate at an angle of substantially 45°.

4. The tool of claim 1 wherein said bottom blade edges on said working plates are rectilinear.

5. The tool of claim 4 wherein said bottom portion of said mounting plate also has a rectilinear edge that lies substantially on said common plane.

6. The tool of claim 1 wherein said mounting plate is of one-piece construction and integrally provides said mounting portion.

7. The tool of claim 1 wherein said mounting portion has a scale thereon with indicia representing the distance between said underlying guide surface and said common plane.

8. The tool of claim 1 wherein said guide piece is in the form of a bracket comprised of first and second panels disposed perpendicular to one another, said first panel comprising said rearwardly extending element having said underlying guide surface thereon, and said second panel engaging said means for attaching.

9. The tool of claim 8 wherein said mounting portion of said mounting plate is formed with a pair of parallel slots extending in said direction of relative movement of said plow head and said guide piece, and wherein said means for attaching comprises a pair of elongate fasteners extending frontwardly from said second panel of said guide piece and slidably received in said parallel slots in said mounting portion.

10. The tool of claim 9 wherein said elongate fasteners have threaded outer end portions, and wherein said means for attaching includes a pair of threaded knobs engaged on said outer end portions of said fasteners.

11. The tool of claim 1 additionally including a handle having engaging structure on an end portion thereof, and wherein said means for attaching a handle comprises engaging structure on said second panel of said guide piece, said tool further including fastener means for pivotably joining said engaging structures on said handle and on said second panel of said guide piece to one another, and for affixing them in selected relative positions.
